(19) United States
(12) Patent Application Publication
(10) Pub. No.: US 2017/0001053 A1
(43) Pub. Date: Jan. 5, 2017

(54) DRUG DISPOSAL SYSTEM

(71) Applicant: Board of Regents, The University of Texas System, Austin, TX (US)

(72) Inventors: Kevin Albert Schug, Southlake, TX (US); Nour Moussa Hussein, Maumelle, AR (US); Shadi Rajai Zamut, Keller, TX (US)

(21) Appl. No.: 15/264,520

(22) Filed: Sep. 13, 2016

Related U.S. Application Data
(63) Continuation-in-part of application No. 15/058,321, filed on Mar. 2, 2016.
Application No. 15/058,321 is a continuation-in-part of application No. 14/889,628, filed on Nov. 6, 2015.
(60) Provisional application No. 61/820,255, filed on May 7, 2013.

(51) Int. Cl. A62D 3/33; B65F 1/02; B09B 3/00

(52) U.S. Cl. CPC A62D 3/33; B09B 3/0008; B09B 3/0075; B65F 1/02; A62D 2101/26

(57) ABSTRACT

The present invention comprises a safe and effective system for removal of a range of common pharmaceutical compounds. The formulation comprises activated carbon, accompanied by some larger pebble-like material to help break up capsules and tablets upon shaking, in the presence of an acidified liquid medium. Drugs are added to the bottle and the bottle is shaken so that the drugs are dissolved by the liquid solution and are irreversibly adsorbed onto activated carbon, thereby sequestering them from further use.

### CROSS-REFERENCE TO RELATED APPLICATIONS

This application is a continuation-in-part of U.S. patent application Ser. No. 14/889,628, filed Nov. 6, 2015, which is a U.S. National Stage of International Patent Application Ser. No. PCT/US2014/037096, filed May 7, 2014 entitled “Drug Disposal System” by Kevin Albert Schug, Nour Moussa Hussein, and Shadi Rajai Zumut, which claims priority to U.S. Provisional Patent Application Ser. No. 61/820,255, and also is a continuation-in-part of U.S. patent application Ser. No 15/058,321, Mar. 2, 2016 which is a continuation-in-part of U.S. patent application Ser. No. 14/889,628. The disclosures of the above-identified co-pending applications are incorporated herein by reference in their entirety.

### BACKGROUND OF THE INVENTION

The invention relates to disposal of chemicals. More specifically the invention relates to safe and effective systems for home, office, hospital, clinic, or governmental disposal of drugs, such as prescription drugs.

The proper disposal of expired and otherwise unused drug compounds is an important issue for both personal health and environmental reasons. There is a clear need for reliable systems which can be used by individual consumers, pharmacies, other health care providers, and governments in order to insure that unused pharmaceuticals are not available for consumption, either abusive or otherwise, or released into the environment due to improper disposal.

### SUMMARY OF THE INVENTION

The present invention comprises a safe and effective system for removal of a range of common pharmaceutical compounds. These compounds possess a range of physicochemical properties (size, solubility, chemical functional units, etc.), and are found in both prescribed and over-the-counter medications.

The formulation comprises activated carbon, accompanied by some larger pebble-like material to help break up capsules and tablets upon shaking, in the presence of an acidified liquid medium.

Drugs are added to the bottle and the bottle is shaken so that the drugs are dissolved by the liquid solution. Active ingredients are irreversibly adsorbed onto activated carbon, thereby sequestering them from further use.

A variety of drug compounds, representing a range of formulations and chemical structures can be effectively inactivated using the system.

### BRIEF DESCRIPTION OF THE DRAWING

FIG. 1 is a drawing of an embodiment of the invention.

### DETAILED DESCRIPTION OF THE INVENTION

The system comprises a formulation of activated carbon, an aqueous acidic solution, and a mechanical dissolution aid delivered in a bottle. The drug is added to the bottle and the bottle is shaken whereupon the drug is dissolved and adsorbed by the activated carbon. The bottle can then be disposed.

The aqueous acidic solution is an aqueous solution of acetic acid and one or more alcohols selected from methanol, ethanol, n-propanol, and isopropanol. In one embodiment, the aqueous acidic solution contains about 5 to about 20% acetic acid and about 10 to about 30% ethanol. In one embodiment, the aqueous acidic solution includes about 12% acetic acid and about 20% ethanol. The acetic acid may be added to the formulation as a 15% aqueous solution (15 ml of glacial acetic acid per 100 ml of water). A 12% acetic acid, 20% ethanol solution may be prepared by mixing 4 parts 15% aqueous acetic acid with 1 part ethanol.

For some applications, the acetic acid/ethanol embodiment may be preferred because the ingredients are environmentally benign. Also, the acetic acid/ethanol formulation may provide a more rapid and complete sequestration for some applications than formulations containing other acids and/or alcohols. Out-gassing of sealed bottles containing certain formulations, such as certain formic acid and methanol formulations, may occur. Acetic acid/alcohol formulations, such as acetic acid/methanol and acetic acid/ethanol, have not exhibited outgassing following initial preparation of the product or in trials with acetaminophen.

In one embodiment, activated carbon is included in an acetic acid/alcohol aqueous solution in an amount of about 25 g per 100 ml of solution. In some embodiments, the amount of activated carbon can vary from about 20 to 35 g/100 ml. The activated carbon can have a variety of mesh sizes and can be powdered activated carbon (PAC) or granulated activated carbon (GAC). It can have a surface area ranging from about 500 m²/g and up to about 1750 m²/g. Examples of activated carbon include GAC 8/20, GAC 12/40, GAC 8/30, K-BG, S-51, Norit SX-4 (PAC), and Norit SX-Ultra (PAC).

The mechanical dissolution aid can be a plurality of pebbles. The pebbles are desirably approximately 0.2-0.7 cm in diameter and irregularly shaped. The amount of pebbles added to the formula can range from one to four times the weight of the activated carbon used. The mechanical dissolution aid prevents clumping of the activated carbon in the sample slurry; it also increases dispersion of the activated carbon in the solution upon shaking.

The aqueous acidic/alcohol solution, activated carbon, and mechanical dissolution aids are placed in a container such as a plastic bottle. Any size bottle can be used. For example, a convenient option is an 8 oz. plastic bottle, which is configured to contain about 4-6 oz. solution, 20 to 50 g of activated carbon, and 40 to 150 g of pebbles. In one embodiment, an 8 oz. bottle (237 mL) bottle contains 50 g of aquarium pebbles, 40 g of powdered activated carbon (Darco KB-G), and 140 mL of solution comprising 4 parts 15% acetic acid (aq.) and 1 part ethanol.

In another embodiment, the container is a one gallon or five gallon container containing similar ingredients in similar proportions. In another embodiment, the container is a drum, such as a 55 gallon drum. Other containers can be used so long as they do not interfere with the ingredients and can preferably be disposed of after use. The bottle or other type of container is provided to the end user having the solution, activated carbon, and mechanical dissolution aid therein. After use, the containers can desirably be securely sealed and disposed. Preferably a bottle is sealed with a child proof top, or another type of seal which cannot be easily reopened.

The bottle is desirably supplied to the end user having an amount of the formulation inside. Preferably the bottle is about 50% filled with the formulation, but it can be more or less filled, generally between about 50% and 90%. The user obtains a system having the capacity needed. Desirably, systems are provided having a capacity of from about 2.5-3 g (in an 8 oz. bottle) to about 3 kg (in a 55 gal. drum) of active drug ingredient (not including inactive ingredients). The bottle drug capacity was determined as a conservative estimate based on trials where increasing doses of acetaminophen tablets were added to a given amount of activated carbon, in order to determine the threshold of non-sequestration. The threshold is likely realistically about 1.5 to 2 times this value.

The drug or drugs are added to the bottle, which is then shaken for a period of time, such as for about two minutes, and allowed to stand for another period of time, such as about one hour. The chemicals contained within the drug product are dissolved by the liquid and irreversibly adsorbed onto the activated carbon, thus rendering them sequestered and inactive.

Any type of drug product can be disposed of using the system, including capsules, tablets, patches, powders, etc., as long as the mass of the active ingredient specified for the given bottle size is not significantly exceeded.

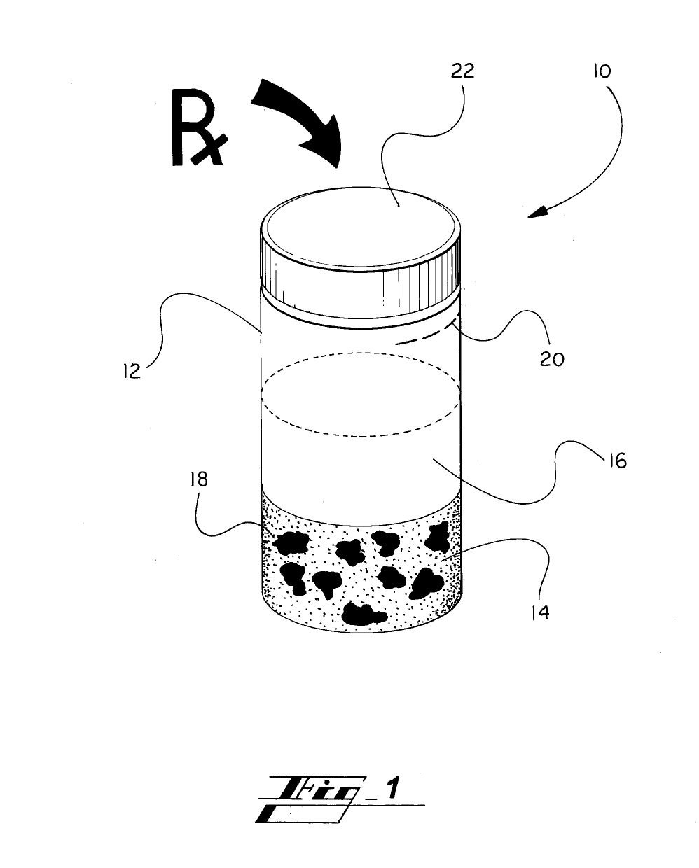

FIG. 1 illustrates an exemplary embodiment of a system 10. Bottle 12 contains fine-grade activated charcoal 14, an acidic solution 16, and pebbles 18. A fill line 20 is indicated on the bottle 12 and the bottle 12 is closed with a cap 22.

The examples below serve to further illustrate the invention, to provide those of ordinary skill in the art with a complete disclosure and description of how the compounds, compositions, articles, devices, and/or methods claimed herein are made and evaluated, and are not intended to limit the scope of the invention. In the examples, unless expressly stated otherwise, amounts and percentages are by weight, temperature is in degrees Celsius or is at ambient temperature, and pressure is at or near atmospheric.

### Example 1

The effectiveness of the system for removal of acetaminophen was tested. Based on past studies, acetaminophen is a good representative drug as a conservative indicator of product performance. Typically, systems that work for acetaminophen work for other drugs. The system included an 8 oz. plastic bottle, 12% acetic acid and 20% ethanol in water, activated carbon, and pebbles. Identical bottle formulations, A, B, and C were prepared as follows:
50 g of aquarium pebbles were added to the 8 oz. polypropylene bottle.
140 mL of a 12% acetic acid/20% ethanol solution (aq.) was added to the bottle.
40 g of powdered activated carbon was added to the bottle. The powdered activated carbon was Darco KB-G.

The bottle was capped tightly and shaken well to mix. Following shaking, the bottle was let stand for 30 minutes capped loosely.

Acetaminophen tablets were introduced into each bottle, and the bottles were shaken well by hand for approximately two minutes, and then allowed to sit for an hour. A sample was taken at one hour, 24 hours, and 48 hours and analyzed by high performance liquid chromatography—mass spectrometry (HPLC-MS). The samples are designated by replicate ID (A, B or C) and sampling time (1, 24, and 48 hours), so that, for example, data from replicate bottle A that was sampled at 1 hour is designated “A1”. The peak area for acetaminophen was monitored and compared to that obtained from an equivalent aliquot of acetaminophen dissolved directly in solution. The analysis was performed on a Shimadzu LCMS-8040 triple quadrupole electrospray ionization—mass spectrometer, operated in the positive ionization mode as has been published (Waybright, V. B.; Ma, S.; Schug, K. A. Validated Multi-Drug Determination using Liquid Chromatography—Tandem Mass Spectrometry for Evaluation of a Commercial Drug Disposal Product. J. Sep. Sci. 2016, 39, 1666-1674). As described in the published method, a standard mobile phase gradient on a biphenyl column (Restek) was used to perform the liquid chromatographic separation in the reversed phase. Appropriate dilutions of the standard solutions and the product solutions were made to ensure that all monitored signals were on scale.

The acetaminophen absorption data for each sample is shown in Table 1. The bottles were visually inspected for bloating and for signs of out-gassing; the out-gassing observations are summarized in Table 2.

TABLE 1
Acetaminophen Absorption

| Sample | Total drug | Free drug in aliquot | Adsorbed |
|---|---|---|---|
| ID | added (mg) | (mg)* | drug (%) |
| A1 | 3000 | 0.54 ± 0.06 | 99.98 |
| A24 | 3000 | 0.16 ± 0.02 | 99.9947 |
| A48 | 3000 | 0.030 ± 0.001 | 99.999 |
| B1 | 3000 | 1.04 ± 0.08 | 99.96 |
| B24 | 3000 | 0.10 ± 0.05 | 99.9967 |
| B48 | 3000 | 0.040 ± 0.003 | 99.9987 |
| C1 | 3000 | 0.66 ± 0.08 | 99.978 |
| C24 | 3000 | 0.19 ± 0.01 | 99.9937 |
| C48 | 3000 | 0.02 ± 0.02 | 99.9993 |

*Mean ± SD, n = 3

TABLE 2
Monitoring of the bottles for out-gassing

| Observation Time | A | B | C |
|---|---|---|---|
| 1 hr after solution mix | Nothing | Nothing | Nothing |
| 2 hrs after solution mix | Nothing | Nothing | Nothing |
| 5 hrs after solution mix | Nothing | Nothing | Nothing |
| 24 hrs after solution mix | Nothing | Nothing | Nothing |
| 1 hr after medicine introduction | Nothing | Nothing | Nothing |
| 24 hrs after medicine introduction | Nothing | Nothing | Nothing |
| 48 hrs after medicine introduction | Nothing | Nothing | Nothing |

### Example 2

The system and analysis as in Example 1 was used, with the exception that the alcohol is either methanol (MeOH) or isopropanol (IPA), and either acetic acid or formic acid is used in the concentrations as shown in Table 3. Tables 4 and 5 show the acetaminophen absorption data and out-gassing observations, respectively.

TABLE 3
Drug Disposal Formulations

| Sample ID | A | B | C | D | E | F |
|---|---|---|---|---|---|---|
| Alcohol | 20% | 20% | 20% | 20% | 20% | 20% |
| | MeOH | MeOH | MeOH | IPA | MeOH | MeOH |
| Acid | 15% | 7% | 0.5% | 15% | 15% | 7% |
| | Formic | Formic | Formic | Formic | Acetic | Acetic |
| | Acid | Acid | Acid | Acid | Acid | Acid |

TABLE 4
Acetaminophen Absorption

| | Total drug | Free drug in aliquot | Adsorbed |
|---|---|---|---|
| Sample | added (mg) | (mg)* | drug (%) |
| A1 | 3000 | 2,172 ± 50 | 27.6 |
| A24 | 3000 | 1076 ± 36 | 64.13 |
| A48 | 3000 | 747 ± 36 | 75.1 |
| B1 | 3000 | 462 ± 10 | 84.6 |
| B24 | 3000 | 435 ± 52 | 85.5 |
| B48 | 3000 | 408.5 ± 56 | 86.38 |
| C1 | 3000 | 2,797.5 ± 56 | 6.75 |
| C24 | 3000 | 2,192 ± 30 | 26.93 |
| C48 | 3000 | 1,481 ± 29 | 50.63 |
| D1 | 3000 | 2,833 ± 29 | 5.57 |
| D24 | 3000 | 1,776.5 ± 33 | 40.78 |
| D48 | 3000 | 1,756.8 ± 134 | 41.44 |
| E1 | 3000 | 1,950 ± 31 | 35.0 |
| E24 | 3000 | 70 ± 11 | 97.67 |
| E48 | 3000 | 56 ± 1 | 98.13 |
| F1 | 3000 | 2,100.5 ± 158 | 29.98 |
| F24 | 3000 | 920 ± 33 | 69.33 |
| F48 | 3000 | 728 ± 21 | 76 |

*Mean ± SD, n = 3

TABLE 5
Monitoring of the bottles for out-gassing

| Observation | | | | | | |
|---|---|---|---|---|---|---|
| time | A | B | C | D | E | F |
| 2 hrs after | Fizz at opening, | Nothing | A lot of fizz | Fizz, a | Fizz, a | Fizz, a |
| solution mix | fume, liquid | | at opening, | little bit of | little bit of | little bit of |
| | droplets | | a lot of | fume, | fume, | fume, |
| | | | fume, liquid | liquid | liquid | liquid |
| | | | droplets | droplets | droplets | droplets |
| 5 hrs after | Nothing | Nothing | Nothing | Nothing | Nothing | Nothing |
| solution mix | | | | | | |
| 21 hrs after | Nothing | Nothing | Nothing | Nothing | Nothing | Nothing |
| solution mix | | | | | | |
| 24 hrs after | Nothing | Nothing | Nothing | Nothing | Nothing | Nothing |
| solution mix | | | | | | |
| 1 hr after | A little bit of | Fizz, fume | A little bit | Fizz, a lot | Almost no | Almost no |
| medicine | fizz, some fume | | of fizz, a | of fume | fume | fume |
| introduction | | | little bit of | | | |
| | | | fume | | | |
| 48 hrs after | Leaks before | Nothing | Nothing | Leaks before | Nothing | Nothing |
| solution mix | opening, but | | | opening, but | | |
| | nothing at | | | nothing at | | |
| | opening | | | opening | | |
| 24 hr after | Nothing | Nothing | Nothing | Nothing | Nothing | Nothing |
| medicine | | | | | | |
| introduction | | | | | | |
| 72 hrs after | Droplets before | Fizz at | Nothing, | Some fizz, | Nothing | Nothing |
| solution mix | opening, the | opening, | inside of the | and some | | |
| | stopper was wet, | inside of | stopper wet | droplets | | |
| | and even the | the stopper | | fell at | | |
| | area of the table | wet | | opening | | |
| | under the bottle | | | | | |
| | was wet. Fizz at | | | | | |
| | opening | | | | | |
| 48 hr after | Nothing | Fizz at | Nothing | Nothing | Nothing | Nothing |
| medicine | | opening | | | | |
| introduction | | | | | | |

Modifications and variations of the present invention will be apparent to those skilled in the art from the forgoing detailed description. All modifications and variations are intended to be encompassed by the following claims. All publications, patents, and patent applications cited herein are hereby incorporated by reference in their entirety.

What is claimed is:

1. A system for disposing of a drug, comprising:
an aqueous solution of acetic acid and one or more alcohols selected from the group consisting of methanol, ethanol, n-propanol and isopropanol;
activated carbon; and
a mechanical dissolution aid;
wherein the solution, activated carbon, and mechanical dissolution aid are provided in a container.

2. The system of claim 1, wherein the aqueous solution comprises from 5 to 20% acetic acid and 10 to 30% ethanol.

3. The system of claim 2, wherein the aqueous solution comprises 12%% acetic acid and 20% ethanol.

4. The system of claim 1, wherein the aqueous solution is used in an amount about 50 to 75% the volume of the container.

5. The system of claim 1, wherein the activated carbon is used in an amount ranging from 20 to 35 grams per 100 ml solution.

6. The system of claim 5, wherein the activated carbon is used in an amount of 25 grams per 100 ml acid solution.

7. The system of claim 1, wherein the activated carbon has a surface area ranging from 500 m²/g to 1750 m²/g.

8. The system of claim 7, wherein the activated carbon is selected from the group GAC 8/20, GAC 12/40, GAC 8/30, K-BG, S-51, Norit SX-4 (PAC), and Norit SX-Ultra (PAC).

9. The system of claim 1, wherein the container is made from a plastic or other material, chosen based on its ability to contain a certain volume of formula, accommodate a certain amount of active ingredient, its inertness, or its disposability.

10. The system of claim 1, wherein the mechanical dissolution aid is a plurality of pebbles.

11. The system of claim 10, wherein the pebbles are approximately 0.2-0.7 cm in diameter and irregularly shaped.

12. The system of claim 10, wherein the pebbles are added in an amount from one to four times the amount of the activated carbon used.

13. The system of claim 1, wherein the capacity of the system to adsorb drug is at least 2.25 g for an 8 oz container.

14. The system of claim 1, wherein the chemicals contained within the drug are dissolved by the solution and adsorbed onto the activated carbon, thus rendering them sequestered and inactive.

15. A method for disposing of a drug, comprising:
providing a system comprising a container containing an aqueous solution of acetic acid and one or more alcohols selected from the group consisting of methanol, ethanol, n-propanol and isopropanol; activated carbon; and a mechanical dissolution aid; and
adding the drug to the container;
wherein the chemicals contained within the drug are dissolved by the solution and adsorbed onto the activated carbon, thus rendering them sequestered and inactive.

16. The method of claim 15, wherein the acid solution comprises from 5 to 20% acetic acid and 10 to 30% ethanol; the acid solution is used in an amount from 50 to 75% the volume of the container; the activated carbon is used in an amount ranging from 10 to 35 grams per 100 ml solution; the activated carbon has a surface area ranging from 500 m²/g to 1750 m²/g;
the mechanical dissolution aid is a plurality of pebbles.

17. The method of claim 16, wherein the acid solution comprises 80% acetic acid (supplied as a 15% aqueous solution) and 20% ethanol.

18. The method of claim 16, wherein the activated carbon is used in an amount of 25 grams per 100 ml acid solution.

19. The method of claim 16, wherein the pebbles are approximately 0.2-0.7 cm in diameter and irregularly shaped.

20. The method of claim 16, wherein the pebbles are added in an amount from one to four times the amount of the activated carbon used
